(19) United States
(12) Patent Application Publication
(10) Pub. No.: US 2004/0009723 A1
(43) Pub. Date: Jan. 15, 2004

(54) Heat adhesion fixing gluey mesh

(76) Inventor: Peng-Chia Tsai, Taoyuan Hsien (TW)

Correspondence Address: BRUCH E. TROXELL, Suite 1404, 5205 Leesburg Pike, Falls Church, VA, 22041, US

(21) Appl. No.: 10/194,219

(22) Filed: Jul. 15, 2002

(51) Int. Cl. B32B 27/04; B32B 5/02; B32B 27/12

(52) U.S. Cl. 442/1; 442/149

(57) ABSTRACT

The heat adhesion fixing gluey mesh for the present invention is a ventilatory colloid mesh shaped as a soft solidity that generate stickiness and adhesion under heat and solidifies into fixing meshed glue at the room temperature. The meshes that allow air to pass through provide good ventilation. The present invention, either the single-layer meshed type or the double-layer meshed type with the sticky paper, provides convenient and flexible application free from the restriction of the infrastructure and conditions. As a result, the colloid contributes to the fixture of the adhered cloth, extending the value and scope of application.

### FIELD OF THE INVENTION

The heat adhesion fixing gluey mesh for the present invention is a ventilatory colloid mesh shaped as a soft solidity that generates stickiness and adhesion under heat and solidifies into fixing meshed glue at room temperature.

### BACKGROUND OF THE INVENTION

In this modern society where people have higher and higher requirement for living, such as beautiful and comfortable cloths. To fulfill these requirements, it takes advanced technology and more adequate accessories other than modernized and artistic eyesight and high-quality materials. In modern light industry, the material of the, such as cloths, shoes and hats and gloves, involves with pasting cloth. In the past, cloth was stuck with solvent glue, which was known for containing organic solvent, such as toluene and Butanone. that damages the environment severely. Therefore, the paster of the cloth is replaced with thermoplastic material or hot melt glue.

Hot melt glue, exclusive of organic solvent, presents as solid material that prevents the operators from the damage caused by benzene. Meanwhile, it does no harm to the atmosphere, winning extensive popularity. However, it requires certain kind of machine to use hot melt glue, which is great inconvenience to infrequent users. Besides, traditional hot melt glue tape requires cloth as the pad, restricting the users in operation that not only reduces the elasticity, but also cuts down the convenience of varied application.

### SUMMARY OF THE INVENTION

The objective of this present invention is to provide a heat adhesion fixing gluey mesh shaping as a soft solidity at room temperature and transforming into fluid under heat.

To achieve the above objective, the hot melt glue of the present invention was shaped into a soft ventilatory mesh whose meshes could be triangle, quadrilateral, circular or beehives. The mesh for the present invention provides good ventilation, smoothness and comfort. In addition, the invention could be single-layer pure glue or double-layer glue combined with mesh so as to attach to the sticky paper to make the soft gluey mesh attached with paper.

Obviously, the advantage of the present invention is providing a user-friendly and flexible application unrestricted from the infrastructure and relative conditions. As a result, the present invention contributes to the fixture of the adhered cloth, extending the value and scope of the application.

### BRIEF DESCRIPTION OF THE DRAWINGS

FIG. 1 is structural diagram about the first operation of the present invention.

FIG. 2 is structural diagram about the second operation of the present invention.

FIG. 3 is diagram about the combination of the meshed glue and the paper for the second operation of the present invention.

### DETAILED DESCRIPTION OF THE INVENTION

The practical operation of the present invention states as follows:

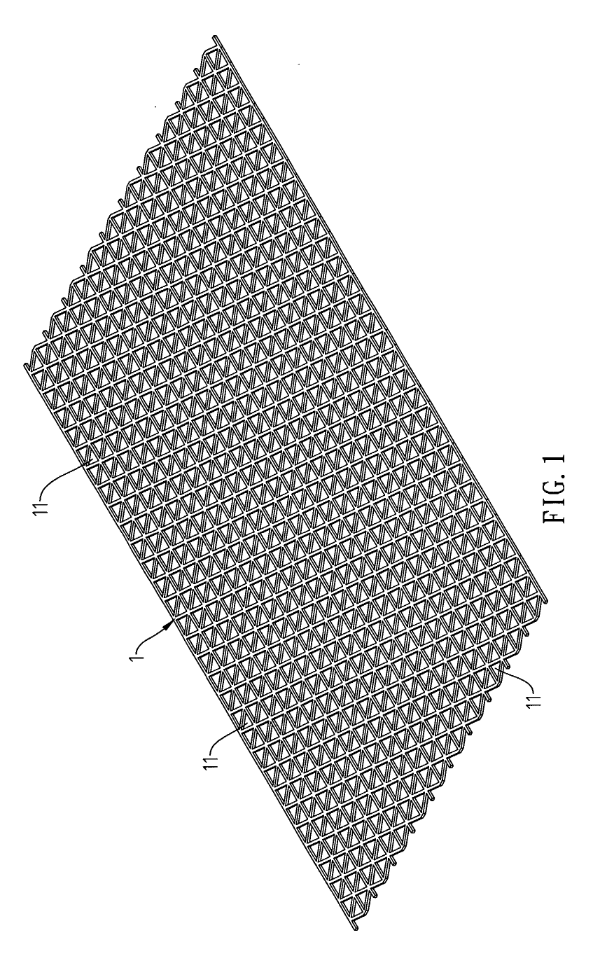

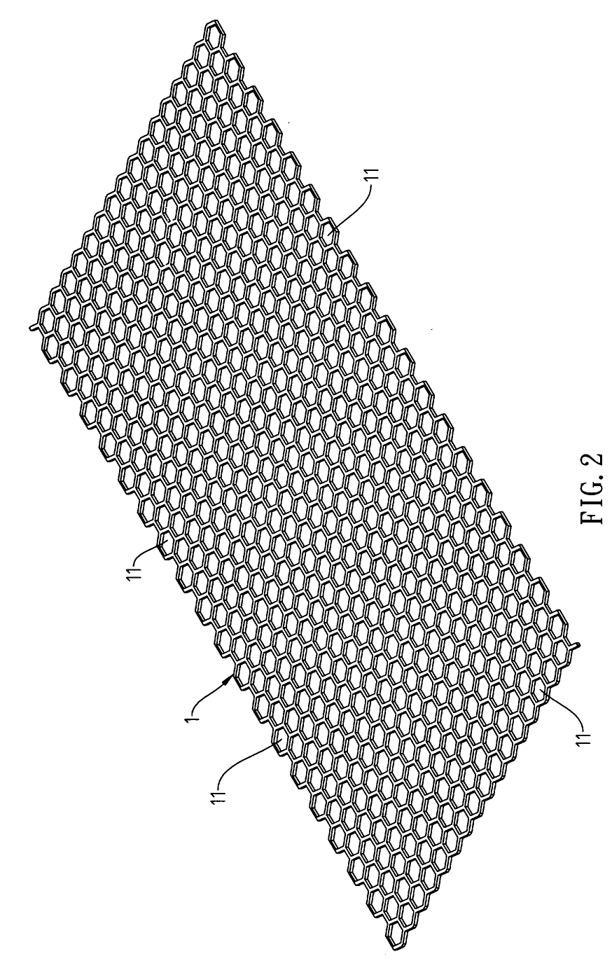

Please refer to FIG. 1 to FIG. 3. The heat adhesion fixing gluey mesh for the present invention 1 whose meshes 11 could be triangle, quadrilateral, circular or beehives is a soft ventilatory mesh. The meshed fixing glue 1 that provides good ventilation, smoothness and comfort with its meshes is a single-layer colloid with pure glue. The smoothness and good ventilation of the single-layer colloid for the present invention provides more practicability and progress, in comparison with traditional gluing approach with hot melt glue, allowing more comfort after combined with the cloth.

During the manufacturing of the meshed fixing glue 1, the user can paint the hot melt glue around the main grained roll wheel for the hot melt glue to form a layer of meshed fixing glue 1 in accordance with the grains of the main roll wheel.

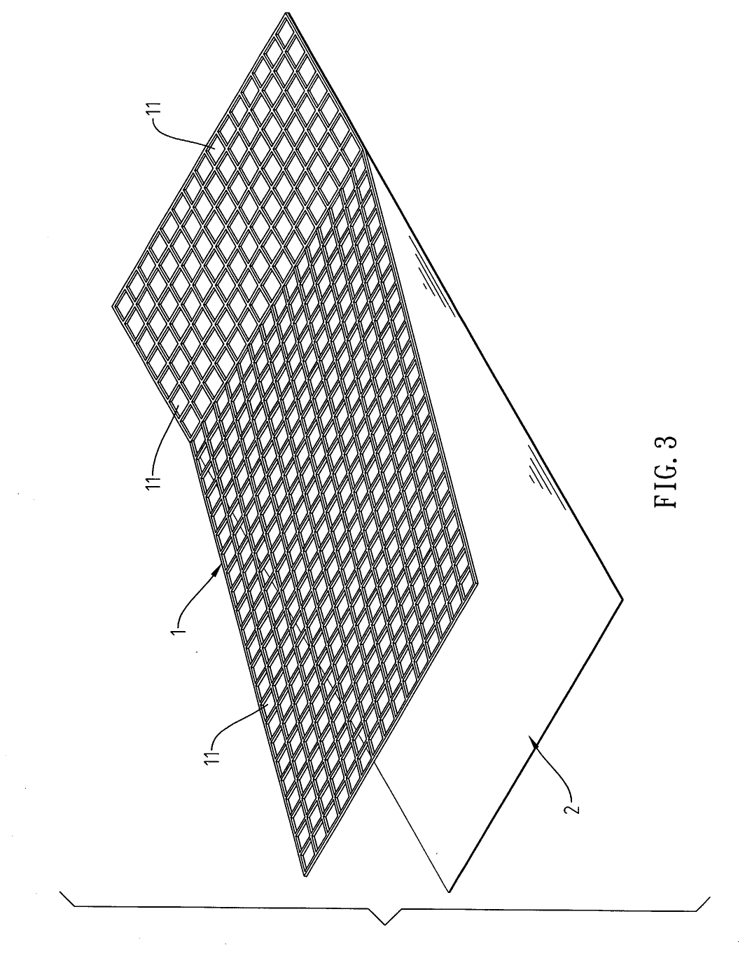

As shown in FIG. 3, the meshed fixing glue 1 could cover over the sticky paper 2 to form a double-layer structure with sticky paper 2.

The meshed fixing glue 1 for the present invention made of hot melt glue is a soft ventilatory mesh. Its meshed appearance generates stickiness and adhesion under heat while solidifies into required shape under the room temperature. The meshes that allow air to pass through provide good ventilation. The present invention, either single-layer or double-layer with the sticky paper, provides convenient and flexible application free from the restriction of the infrastructure and relative conditions. As a result, the colloid contributes to the fixture of the adhered cloth, extending the value and scope of application.

Codes and Descriptions:

| | Meshed fixing glue |
|---|---|
| 11 | mesh |
| 2 | Sticky paper |

What is claimed is:

1. A heat adhesion fixing gluey mesh, said fixing gluey mesh is a soft ventilatory mesh.

2. The heat adhesion fixing gluey mesh of claim 1, wherein said meshes of said meshed fixing glue can be triangle, quadrilateral, circular and beehive-shaped.

3. The heat adhesion fixing gluey mesh of claim 1, wherein said meshed fixing glue can be covered over sticky paper to make a double-layer structure with said sticky paper.
